(19) United States
(12) Patent Application Publication
(10) Pub. No.: US 2005/0288912 A1
(43) Pub. Date: Dec. 29, 2005

(54) Method and apparatus for simulating mass and heat transfer-controlled separation processes

(75) Inventors: Norbert Asprion, Mannheim (DE); Christoph Grossmann, The Woodlands, TX (US); Bernd Hegner, Ludwigshafen (DE); Jurgen Ruhnke, Dannstadt-Schauernheim (DE); Torsten Katz, Neustadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/202,333

(22) Filed: Aug. 12, 2005

Related U.S. Application Data
(63) Continuation of application No. PCT/EP04/01162, filed on Feb. 9, 2004.

(30) Foreign Application Priority Data
Feb. 14, 2003 (DE) 103 07 233.0

(51) Int. Cl. G06G 7/48; G06G 7/50

(52) U.S. Cl. 703/9

(57) ABSTRACT

Method of simulating mass and heat transfer-controlled separation processes using a core-film approach to describe a transfer taking place at a phase boundary (P) in which, for iteratively solving a suitable implicit differential equation system, discretisation of a transitional area (10) of the core-film approach under consideration is carried out, thereby resulting in a differential equation system.

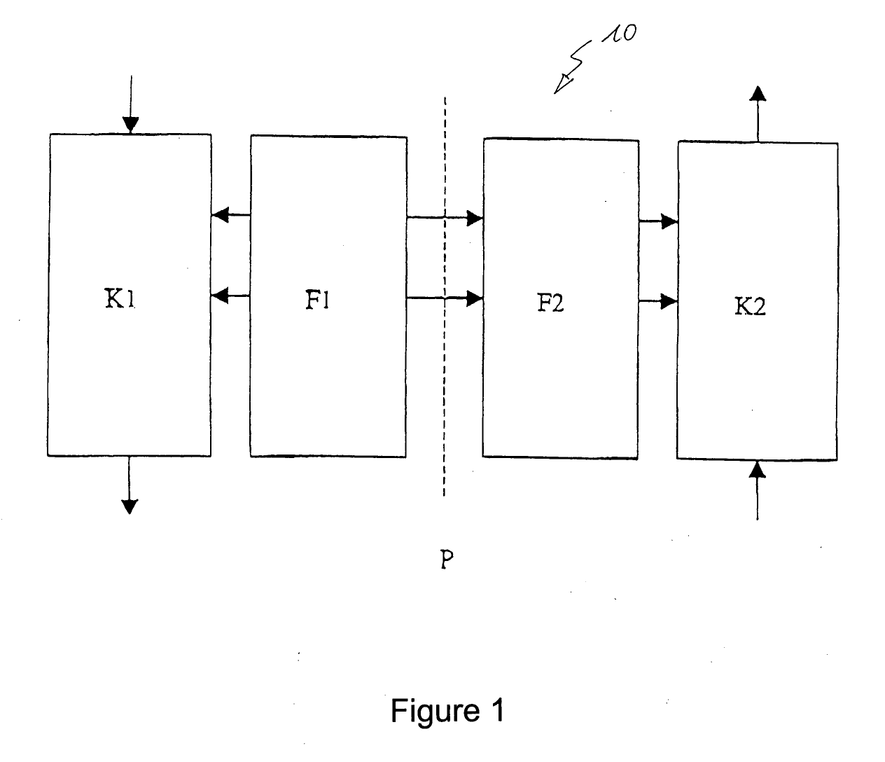

The present invention relates to a method and an apparatus for simulating mass and heat transfer-controlled separation processes, particularly phase transitions with chemical/physical correlations or connections between a number of phases, as occurs for example in multicomponent separation processes such as extractions, rectifications, absorptions or in reactors. The invention is applicable in particular to the field of modeling charging and packing columns.

The simulation of mass and heat transfer between phases in contact in chemical/physical separating equipment is usually carried out by switching so called “equilibrium stages”. In the example of describing the simulation of a distillation column, “equilibrium stages” are used in counter-current switching, the out flowing currents of liquid and vapour being in thermodynamic equilibrium in an equilibrium stage. This is a simplified model which is sufficiently accurate to image the actual process in a number of cases but is not appropriate in certain cases. Thus, the use of equilibrium stage columns of this kind generally produces false results when simulating chemisorption and similar processes, for example.

It is known that a more accurate and better formulation can be achieved if the apparatus is described using a mass and heat transfer model in which the phases in contact are not in thermodynamic equilibrium with one another but exchange mass and energy in controlled and restricted manner. Examples of such models are the surface renewal theory, penetration theory or two-film theory. The latter is a standard method of describing the transfer of mass and heat in which the various phases are described by a core and a film, the mass and heat being exchanged between the phases through the film. There is thermodynamic equilibrium at the phase boundary between the films only. When modeling mass transfer between the core and the phase boundary the theory of Stefan and Maxwell is applied according to which the mass transfer current are coupled, i.e. the amounts of mass transfer of the individual components also depend on the other components.

The Stefan-Maxwell equation is particularly suitable for describing multicomponent diffusion. It includes the influence of the diffusion of a plurality of components. The Stefan-Maxwell equations form a non-linear implicit system of equations with special properties. These equations are partial differential equations, while in the case of ν components only ν-1 equations are linearly independent. For the extreme case of infinitely large mass transfer surfaces the solution of the equation system merges into the thermodynamic equilibrium, whereas for simple situations, e.g. an equamolar mass transfer, simpler models such as Fick's Law are used. The theoretical advantage of Fick's Law which is important to the practice of simulation is in particular the fact that the equations in the merging mass currents are explicit.

Starting from the simplifications mentioned above the known methods of solving the coupled mass and heat transfer are designed so that corrections are made to the simple equations to achieve a more precise description. This applies in particular to all those models with which packing columns can be simulated and interpreted.

From Higler et al. “Non-equilibrium cell model for multi component (reactive) separation processes”, AIChE Journal, November 1999, Vol. 45, No. 11, pages 2357 to 2370, a method with an implicit solution of the Stefan-Maxwell equations is known; however, it is limited to modeling a base column which is described by putting together a number of model blocks. This linking of a number of model blocks takes account of the particular problems of an incomplete cross-mixing on a base (of a column).

The known simulation methods with the so called equilibrium apparatus fail chiefly in all the technical apparatus and applications which are mass transfer-limited. Examples of these are distillation columns, (particularly in the fields of reactive distillation and distillation of long-boiling mixtures), absorption and desorption columns, membrane contactors (e.g. in the form of absorption or desorption contactors), washers (Venturi or spray washers), evaporators (e.g. thin layer and short path evaporators for separating monomers from polymers) and condensers (e.g. condensation from a current of inert gas) or multiphase reactors (bubble columns, jet loops).

Kenig describes in “Multicomponent multiphase film-like systems: A modelling approach”, Computers Chem. Engng., vol. 21, Suppl., 1997, pages 355 to 360, XP001182102, an approach for modeling separation processes of multicomponent mixtures, particularly modeling of a mass and heat transfer-controlled separation process using the core-film-approach. There, the partial differential equations resulting from the arrangement of the Stefan-Maxwell-equations are solved numerically (i.e. discretised) and iteratively using the Newton-Raphson-method (for the hydrodynamical part).

Starting from this the invention proposes a method and an apparatus for simulating mass and heat transfer-controlled separation processes having the features of claim 1 and claim 16, respectively. Accordingly, the simulation is effected using a core-film approach, known per se, to describe a mass and heat transfer taking place at a phase interface, while in order to solve a suitable differential equation system, particularly on the basis of the Stefan-Maxwell equation, discretisation of a particular transfer segment of the core-film approach under observation is used. An apparatus according to the invention is, in particular, a computer-assisted simulator. In addition, a computer programme with programme code or programme coding means and a computer readable data carrier medium with a computer programme having the features of claim 31 and claim 32, respectively, are claimed.

The invention is the technical implementation of a boundary value problem for a partial differential equation system in which one of the integration variables is the height coordinate of the apparatus in the direction of flow of one phase and the other integration variables point in the direction of the mass and heat transfer between the particular phases.

This differential equation system can be solved for example using an adaptive method as used in diffusion processes. However, for calculating processes in counterflow mass transfer apparatus, it is particularly advantageous if methods are used which lead to an equation system which corresponds in its structure to the counterflow equilibrium columns mentioned hereinbefore. This is the case, for example, when the differential equations in the direction of flow are solved using a differential method such as for example the Euler method (first order) or the Trapezium rule (second order) or a higher order method (e.g. the Simpson Rule). As a result of this discretisation, elements are obtained which can be referred to as mass and heat transfer segments.

These segments in turn contain partial differential equations with regard to the coordinates in the direction of the transfer between the different phases. Advantageously, these differential equations are also solved using differential methods. As a result of this discretisation, other elements are obtained which are referred to as film segments according to the invention. As mentioned above, in simple cases such as, for example, the equimolar mass transfer between only two phases, common linear differential equations are obtained with regard to the direction of the mass transfer between the two phases which are explicit in the transitional molar flow rates. In all other cases there are implicit equations in view of the transitional molar flow rates (or molar flows).

As the result of this method, non-linear equations are obtained for each individual segment and each individual film segment. The resulting non-linear equation system is iteratively solved, most advantageously using the Newtonian method. The variables are:

for a core phase: Composition
Temperature
(Molar) flow rate
Heat currents

for a film segment: Composition
Temperature
Mass transfer flow
eat transfer flow

for a phase boundary: Equilibrium composition for
each phase
Equilibrium temperature
Mass transfer flow
Heat transfer flow

In addition to this there might be equations which describe reaction conversion rates or, in the case of electrolyte reactions, equations for describing electro-neutrality.

By means of a differential approach the invention makes it possible by discretisation to arrive at an implicit solution to a differential equation system, particularly the Stefan-Maxwell equations, without the drawbacks which accompany the simplifications which are the approximations known from the prior art.

It is particularly useful to apply the non-equilibrium approach according to the invention to apparatus in which there are chemical reactions overlying the mass transfer, as is the case for example in acid gas washing. Acid gas washing is chemisorption in which acid gases such as CO₂, H₂S, COS or mercaptans are eliminated from a carrier gas current by means of a liquid absorption agent. Applications for this may be found for example in the field of natural gas purification, the purification of ammonia and synthetic gas and the purification of flue gas and combustion exhaust gases. In fast reactions there may be an improvement in the mass transfer in the film segment, as the potential difference which is crucial to the mass transfer can be increased by a reaction in the film segment. The method according to the invention ensures that account is taken of additional processes which influence the mass transfer, such as high speed chemical reactions or electro-neutrality in electrolytic reactions. The invention is also suitable for carrying out the modeling of apparatus with any number of phases and different phase combinations (e.g. liquid/liquid extractions, vapour/liquid/liquid rectifications or solid/liquid reactors).

According to an advantageous embodiment the method according to the invention comprises the following steps:
Determining a transition range which extends over a phase boundary,
Defining at least two core phases with associated films in the transition range,
Discretising the core phases with associated films in the direction of flow of the core phases into individual transfer segments,
Iteratively solving the implicit differential equation system.

According to a particularly advantageous feature, the films are additionally discretised in the direction of diffusion. This allows simulation of the process operations during mass transfer over phase boundaries which is very correct in its details, with convective mass transfer being predominant in the core phases and diffusive mass transfer being predominant in the films.

According to one embodiment of the invention, in order to estimate the film thickness for mass transfer in the film, the two film theory, penetration theory or surface renewal theory is used. For this, the correlation between the mass transfer coefficient, diffusion coefficient and film thickness for the laminar film is used. The mass transfer coefficients may be determined, e.g. for charging, packing or base columns, according to correlations known from the literature. One correlation of this type is described for example in Onda K., Takeuchi H. and Okumoto Y., “Mass Transfer Coefficients between Gas and Liquid Phases in Packed Columns”, J. Chem. Eng., Japan, 1, (1968) page 56. The diffusion coefficients can be determined by means of equations known from the literature such as, e.g., the Wilke-Chang or Nernst equations. Within the scope of modeling a process, knowledge of the effective surface area available for the mass transfer (between the phases) is relevant.

According to a further feature of the invention the effective mass transfer surface area can also be determined by correlations. Frequently, in the mass transfer correlations, in addition to the correlations for the mass transfer coefficients a correlation is also given for the effective mass transfer surface area (cf. for example Onda et al. 1968).

Of course, it is possible by means of the invention to look at both stationary and dynamic processes by incorporating a time-dependent approach in the equation system, depending on the desired solution approach, and applying the existing variables in time-dependent manner. The inclusion of time dependency then enables a time pattern to be simulated in the event of faults in a non-equilibrium apparatus. Without time dependency a prediction is obtained as to the final state after a fault.

Further advantages and features of the invention will become apparent from the description and the accompanying drawing.

It will be understood that the features mentioned above and those to be described hereinafter may be used not only in the particular combination specified but also in other combinations or on their own, without departing from the scope of the present invention.

The invention is diagrammatically (schematically) shown in the drawing, by means of an exemplifying embodiment, and is hereinafter described in detail with reference to the drawing.

The sole FIGURE shows a transition range according to the invention, in highly schematic view. This transition range 10 extends over a phase boundary P which divides two phases from one another. This may be a comparatively simple case such as a liquid/vapour phase boundary but there may also be other combinations as mentioned hereinbefore.

In the transition range 10, on either side of the phase boundary P are defined a core phase K1 and K2, respectively, and a film segment F1 and F2 associated with the particular core phase K1, K2 and adjacent to the phase boundary P. Moreover, any desired number of heat and mass currents may be added to or subtracted from the core phases.

This transition region forms the basis for the application of the original, i.e. implicit Stefan-Maxwell equations on the basis of the so called two-film theory.

According to the invention, in order to solve the differential equations thus obtained, the transition region is discretised into transfer segments, i.e. into non-equilibrium segments in the direction of flow of the core phases. The differential equation set is then solved numerically iteratively for all these transfer segments thus obtained.

It has proved particularly advantageous to carry out discretisation in the film segments as well, particularly in cases where reactions also occur in the film segments (as in acid gas washing, for example).

Moreover, it has proved particularly advantageous to carry out the discretisation in the direction of flow of the core phases at different intervals, specifically in fine steps in areas with a major change of state and in large steps in areas with a minor change of state. The film thicknesses of the films F1, F2 can selectively be preset/given or determined from correlations of measured mass transfer coefficients and diffusion coefficients. Correlations may be used, for example, for bubble columns or different packings such as structured packings or fillers. Similarly, the effective mass transfer surface can be calculated by means of correlations.

When discretising the films it has proved particularly advantageous if the discretisation points or so called support points (i.e. the intervals of the discrete subdivision) are closer towards the core phase and towards the phase boundary as these are generally where the most serious changes occur. The film thickness is also used to calculate the “hold-up” of the film for reactions, i.e. the volume available for reaction in the film and hence for the retention time.

The heat transfer through the film may be calculated selectively by taking account of the conduction of heat in the film or, however, by using a heat transfer coefficient which may be estimated, for example, using the Chilton-Colburn analogy.

The present invention allows easy and effective computer aided simulation of mass transfer-controlled separation processes, yielding very accurate results for a comparatively low computing intensity. The invention is particularly suitable for simulating the processes in columns and for modeling columns, particularly charging and packing columns. It is also possible to simulate and model both absorptions (gas/liquid phases) and extractions (liquid/liquid phases) and also multiple phases without any difficulty, while also taking into account chemical reactions (equilibrium reactions, kinetically controlled reactions) which take place in the (nuclear and film) phases, and thus affect the mass and energy balances.

1. Method of simulating mass and heat transfer-controlled separation processes using a core-film approach to describe a transfer taking place at a phase boundary (P) in which, for iteratively solving a suitable implicit differential equation system, discretisation of a transitional area (10) of the core-film approach under consideration is carried out, thereby resulting in a differential equation system.

2. Method according to claim 1 comprising the following steps:
Determining a transitional region (10) extending over a phase boundary (P),
Defining at least two core phases (K1, K2) with associated films (F1, F2) in the transitional region (10),
Discretising the core phases (K1, K2) with the associated films (F1, F2) in the direction of flow of the core phases into individual transfer segments,
Iteratively solving the implicit differential equation system.

3. Method according to claim 1 or 2, wherein additional discretising of the films (F1, F2) is carried out in the direction of diffusion.

4. Method according to claim 2, wherein a thickness of the films (F1, F2) is determined from correlations for the mass transfer coefficient and for the diffusion coefficient.

5. Method according to claim 2, wherein the two film theory, penetration theory or surface renewal theory is used to estimate the film thickness for mass transfer in the film.

6. Method according to one of claims 1 to 5, wherein the transfer segment is a mass and/or heat transfer segment.

7. Method according to one of the preceding claims, wherein the differential equation system contains the Stefan-Maxwell equations.

8. Method according to one of the preceding claims, wherein the discretisation is carried out in the direction of flow and/or the direction of diffusion in fine steps, for major changes of state, and in large steps, for minor changes of state.

9. Method according to one of the preceding claims, wherein the differential equation system is solved using an integration method of the first order, for example the Euler method.

10. Method according to one of claims 1 to 8, wherein, in order to solve the differential equation system, an integration method of the second order, for example the Trapezium Rule, is used.

11. Method according to one of claims 1 to 8, wherein in order to solve the differential equation system an integration method of the n^{th} order, for example the Simpson Rule, is used.

12. Method according to one of the preceding claims, wherein the nuclear film approach is the two-film theory.

13. Method according to one of the preceding claims, wherein reactions in the nuclear and film phases are taken into consideration by means of mass and/or energy balances.

14. Method according to one of the preceding claims, wherein the Newtonian method is used for iteratively solving the differential equation system.

15. Method according to one of the preceding claims, wherein a mass transfer area is determined using correlations.

16. Apparatus for simulating mass and heat transfer-controlled separation processes using a core film approach to describe a transfer taking place at a phase boundary (P), comprising a computer unit, an inputting unit and a display unit, wherein a differential equation system resulting from a suitable implicit differential equation system based on a discretisation of a transition area (10) of the core film approach under consideration is solved iteratively.

17. Apparatus according to claim 16, wherein a transition area (10) extending over a phase boundary (P) is determined, at least two core phases (K1, K2) with associated films (F1, F2) in the transition area (10) are defined, the core phases (K1, K2) with the associated films (F1, F2) are discretised in the direction of flow of the core phases into individual transfer segments, and the implicit differential equation system is iteratively solved.

18. Apparatus according to claim 16 or 17, wherein additional discretisation of the films (F1, F2) in the direction of diffusion is carried out.

19. Apparatus according to claim 17, wherein a thickness of the films (F1, F2) is determined from correlations for the mass transfer coefficient and for the diffusion coefficients.

20. Apparatus according to claim 17, wherein the two-film theory, penetration theory or surface renewal theory is used to estimate the film thickness for the mass transfer in the film.

21. Apparatus according to one of claims 16 to 20, wherein the transfer segment is a mass and/or heat transfer segment.

22. Apparatus according to one of claims 16 to 21, wherein the differential equation system contains the Stefan-Maxwell equations.

23. Apparatus according to one of claims 16 to 22, wherein the discretisation in the direction of flow and/or in the direction. of diffusion is carried out in fine steps for major changes of state and in large steps for minor changes of state.

24. Apparatus according to one of claims 16 to 23, wherein an integration method of the first order, e.g. the Euler method, is used to solve the differential equation system.

25. Apparatus according to one of claims 16 to 23, wherein an integration method of the second order, e.g. the Trapezium Rule, is used to solve the differential equation system.

26. Apparatus according to one of claims 16 to 23, wherein an integration method of the n^{th} order, e.g. the Simpson Rule, is used to solve the differential equation system.

27. Apparatus according to one of claims 16 to 26, wherein the core-film approach is the two-film theory.

28. Apparatus according to one of claims 16 to 27, wherein reactions in the nuclear and film phases are taken into consideration by means of mass and/or energy balances.

29. Apparatus according to one of claims 16 to 28, wherein the Newtonian method is used for iteratively solving the differential equation system.

30. Apparatus according to one of claims 16 to 29, wherein a mass transfer surface area is determined by correlations.

31. Computer programme with programme code which performs a method according to one of claims 1 to 15 when the computer programme is run on a suitable computer system.

32. Computer programme product with programme code which performs a method according to one of claims 1 to 15 when the computer programme is run on a suitable computer system.

33. Computer readable data carrier medium with a computer programme stored thereon, the computer programme comprising programme coding means which perform a method according to one of claims 1 to 15 when the computer programme is run on a suitable computer system.
